(19) United States
(12) Patent Application Publication
(10) Pub. No.: US 2024/0056851 A1
(43) Pub. Date: Feb. 15, 2024

(54) METHOD AND APPARATUS FOR ANALYZING PERFORMANCE OF WIRELESS COMMUNICATION SYSTEM

(71) Applicant: Samsung Electronics Co., Ltd., Suwon-si (KR)

(72) Inventors: Jungshin PARK, Suwon-si (KR); Dongyeon KIM, Suwon-si (KR)

(21) Appl. No.: 18/365,498

(22) Filed: Aug. 4, 2023

(30) Foreign Application Priority Data
Aug. 9, 2022 (KR) 10-2022-0099578

(51) Int. Cl. H04W 24/08; H04L 41/14; H04W 36/00

(52) U.S. Cl. CPC H04W 24/08; H04L 41/14; H04W 36/0011

(57) ABSTRACT

A method and an apparatus for collecting and analyzing session performance data in a wireless communication system are provided. The method includes receiving a first request message for requesting network performance analytics from a policy control function (PCF), transmitting a second request message for requesting data collection for the network performance analytics to at least one network function (NF) of a first network related to session performance of a user equipment (UE), receiving a first notification message including session performance data of the first network and an indicator indicating that the UE moves to a second network from the at least one network function, and transmitting, to the PCF, a second notification message including a performance analytics result of the session performance data.

### CROSS-REFERENCE TO RELATED APPLICATION(S)

This application is based on and claims priority under 35 U.S.C. § 119(a) of a Korean patent application number 10-2022-0099578, filed on Aug. 9, 2022, in the Korean Intellectual Property Office, the disclosure of which is incorporated by reference herein in its entirety.

### BACKGROUND

### 1. Field

The disclosure relates to a method and an apparatus for collecting and analyzing performance data transmitted by a user equipment (UE) through a network in a wireless communication system.

### 2. Description of Related Art

Fifth generation (5G) mobile communication technology defines a wide frequency band to enable fast transmission speed and new services and may be implemented in frequencies below 6 giga hertz (GHz) (‘sub 6 GHz’), such as 3.5 GHz, as well as in ultra-high frequency bands (‘above 6 GHz’), such as 28 GHz and 39 GHz called millimeter wave (mmWave). Further, sixth generation (6G) mobile communication technology, which is called a beyond 5G system, is considered to be implemented in terahertz bands (e.g., 95 GHz to 3 THz) to achieve a transmission speed 50 times faster than 5G mobile communication technology and ultra-low latency reduced by 1/10.

In the early stage of 5G mobile communication technology, standardization was conducted on beamforming and massive multiple-input multiple-output (MIMO) for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as low density parity check (LDPC) code for massive data transmission and polar code for high-reliable transmission of control information, L2 pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the voice over new radio (VoNR), new radio unlicensed (NR-U) aiming at the system operation matching various regulatory requirements, NR UE power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step random access channel (RACH) for NR to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, soaring connected devices would be connected to communication networks so that reinforcement of the function and performance of the 5G mobile communication system and integrated operation of connected devices are expected to be needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Further, development of such 5G mobile communication systems may be a basis for multi-antenna transmission technology, such as new waveform for ensuring coverage in 6G mobile communication terahertz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of terahertz band signals, AI-based communication technology for realizing system optimization by embedding end-to-end AI supporting function and using satellite and artificial intelligence (AI) from the step of design, and next-generation distributed computing technology for implementing services with complexity beyond the limit of the UE operation capability by way of ultrahigh performance communication and computing resources.

With the development of mobile communication systems as described above, various services may be provided, and as wireless communication systems become more complex and diverse, the need for a technology that analyzes the transmission performance of UEs within a wireless communication system and controls them to set an appropriate transmission route selection policy based on this analytics has arisen.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for collecting and analyzing performance data of a user equipment (UE) in a wireless communication system.

Another aspect of the disclosure is to provide a method and an apparatus for collecting performance data of a UE by a network entity that provides a data analytics and collection function in a wireless communication system.

Another aspect of the disclosure is to provide a method and an apparatus for controlling a signal flow between network functions (NFs) for collecting the performance data of a UE.

Another aspect of the disclosure is to provide a method and an apparatus for controlling a series of signal flows for transferring a route selection policy appropriate for a UE based on the results of collecting and analyzing the performance data of a UE in each network.

Additional aspects will be set forth in part in the description which follows and, in part, will be apparent from the description, or may be learned by practice of the presented embodiments.

In accordance with an aspect of the disclosure, a method for collecting and analyzing session performance data in a wireless communication system is provided. The method includes receiving a first request message for requesting network performance analytics from a policy control function (PCF), transmitting a second request message for requesting data collection for the network performance analytics to at least one network function (NF) of a first network related to session performance of a user equipment (UE), receiving a first notification message including session performance data of the first network and an indicator indicating that the UE moves to a second network from the at least one network function, and transmitting, to the PCF, a second notification message including a performance analytics result of the session performance data.

In accordance with another aspect of the disclosure, an apparatus in a network data collection and analytics function (NWDAF) of a wireless communication system is provided. The apparatus includes a communication interface, a memory, and at least one processor. The at least one processor is configured to receive a first request message for requesting network performance analytics from a policy control function (PCF), transmit a second request message for requesting data collection for the network performance analytics to at least one network function (NF) of a first network related to session performance of a user equipment (UE), receive a first notification message including session performance data of the first network and an indicator indicating that the UE moves to a second network from the at least one network function, and transmit, to the PCF, a second notification message including a performance analytics result of the session performance data.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a configuration of a wireless communication network including a network data collection and analytics function (NWDAF) according to an embodiment of the disclosure;

FIGS. 2A and 2B are signal flowcharts illustrating a network data collection and analytics operation according to various embodiments of the disclosure;

FIGS. 3A and 3B are signal flowcharts illustrating a network data collection and analytics operation according to various embodiments of the disclosure;

FIG. 4 is a signal flowchart illustrating a network data transfer operation according to an embodiment of the disclosure;

FIG. 5 is a block diagram illustrating a configuration of a UE according to an embodiment of the disclosure; and

FIG. 6 is a block diagram illustrating a configuration of a network entity according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments of the disclosure, the functions mentioned in the blocks may occur in different orders. For example, two blocks that are consecutively shown may be performed substantially simultaneously or in a reverse order depending on corresponding functions.

As used herein, the term “unit or part” means a software element or a hardware element, such as a field-programmable gate array (FPGA) or an application specific integrated circuit (ASIC). A ‘unit’ or ‘part’ may be configured to play a certain role. However, a ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more central processing units (CPUs) in a device or secure multimedia card. According to embodiments of the disclosure, a “ . . . unit” may include one or more processors and/or devices.

For ease of description, some of the terms or names defined in the 3rd generation partnership project (3GPP) long-term evolution (LTE)-based communication standards (e.g., 5G, NR, LTE, or similar system standards) may be used. However, the disclosure is not limited by such terms and names and may be likewise applicable to systems conforming to other standards.

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings.

The description of embodiments of the disclosure focuses primarily on the radio access network, new radio access network (RAN) (NR), and the core network, packet core (5G system, or 5G core network, or NG core, or next generation core), which are specified by the 3rd generation partnership project (3GPP) which is a mobile communication standardization organization. However, the subject matter of the disclosure, or slight changes thereto, may also be applicable to other communication systems that share similar technical backgrounds without departing from the scope of the disclosure, which would readily be appreciated by one of ordinary skill in the art.

In the 5G system, network data collection and analytics function (NWDAF) which is a network function for analyzing the data collected from the 5G network and providing it may be defined to support network automation. The NWDAF may collect/store/analyze information (e.g., network data, performance data, and/or network performance data) from the 5G network and provide the analytics results to at least one network function (NF). Each NF may independently use the analytics results.

The 5G mobile communication system supports the NFs to use the results of collection and analytics of network-related data (hereinafter referred to as network data) through the NWDAF. This is to provide the collection and analytics of network data necessary for each NF to effectively provide its own functions in a centralized form. The NWDAF may collect and analyze network data using a network slice as a basic unit. However, the scope of the disclosure is not limited to the network slice unit, and the NWDAF may additionally analyze various pieces of information (e.g., service quality) including at least one of user equipment (UE), protocol data unit (PDU) session, NF state, and/or quality of service obtained from a service server of an external network.

The results (e.g., analytics results) analyzed through the NWDAF may be delivered to each NF that requests the analytics results, and the delivered analytics results may be used to optimize network management functions, such as ensuring/enhancing quality of service (QoS), traffic control, mobility management, and load balancing.

A unit node performing each function provided by the 5G network system may be defined as an NF (or also referred to as NF entity or NF node). At least one NF may include at least one of, e.g., an access and mobility management function (AMF) that manages access and mobility of the user equipment (UE) to an access network (AN), a session management function (SMF) that performs session-related management, a user plane function (UPF) that manages the user data plane, or a network slice selection function (NSSF) that selects network slice instances available to the UE.

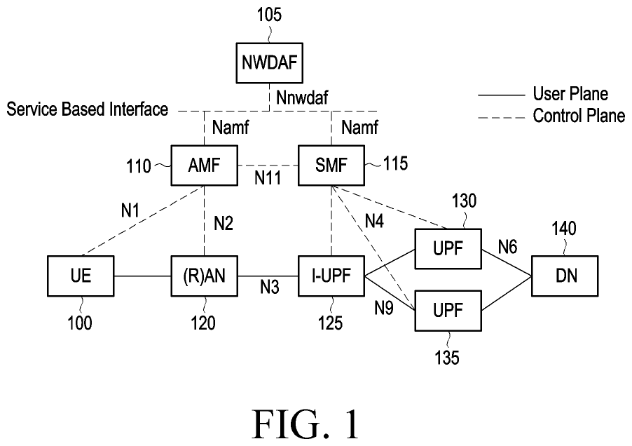

FIG. 1 is a view illustrating a configuration of a wireless communication network including a network data collection and analytics function (NWDAF) according to an embodiment of the disclosure.

Referring to FIG. 1, an NWDAF 105 may collect, in various manners, network data (e.g., performance data or network performance data) from at least one source NF, e.g., NFs in the 5G core network, such as an AMF 110, an SMF 115, or the UPFs 125, 130, and 135, an application function (AF) (not shown) for efficiently providing a service, a network exposure function (NEF) (not shown), or an operation, administration, and maintenance (OAM) (not shown). The AMF 110 may access a user equipment (UE) 100 and a radio access network (RAN) 120, and the UPF 125,130,135 may connect user traffic of the UE 100 through the RAN 120 to at least one data network (DN) 140.

In an embodiment of the disclosure, the NWDAF 105 may provide at least one consumer NF with analytics of network data collected in the network or externally. The NWDAF 105 may collect and analyze the load level of the network slice instance and provide it to the NSSF (not shown) to be used for selection to be used by a specific UE. The service-based interface defined in the 5G network may be used to request or transfer analytics information including analytics results between the NFs (e.g., AMF 110 and/or SMF 115) and the NWDAF 105, and a hypertext transfer protocol (HTTP) and/or JavaScript object notation (JSON) document may be used as the transfer method.

As an example, the data collected by the NWDAF 105 may include at least one of the application identifier (ID) from the policy control function (PCF) (not shown), internet protocol (IP) filter information, media/application bandwidth, the UE identifier from the AMF, location information, destination data network name (DNN) from the SMF, UE IP, QoS flow bit rate, QoS flow ID (QFI), QoS flow error rate, QoS flow delay, or traffic usage report from the UPF.

The NWDAF 105 may additionally collect and use for analytics, at least one of, e.g., the NF resource status, NF throughput, service level agreement (SLA) information, UE status from the UE 100, UE application information, UE usage pattern, the service application identifier received from the AF, service experience, or traffic pattern from the OAM, which is an entity capable of influencing connection between the UE 100 and the service server, other than the NFs (e.g., the UPFs 125, 130, and 135, the AMF 110, and/or the SMF 115) constituting the core network.

Tables 1, 2, and 3 below show example network data collected by the NWDAF 105. The network data collected by the NWDAF 105 may include at least one of information elements to be described below. The period and time when the NWDAF 105 collects network data from each entity may differ from entity to entity. Further, the correlation between the collected data may be identified through the timestamp for recording the time of collection and the correlation ID for correlating the network data of each collection target.

TABLE 1

| Information | Source | Description |
|---|---|---|
| Application | AF | To identify the service and support analytics per |
| ID | | type of service (the desired level of service) |
| IP filter | AF | Identify a service flow of the UE for the |
| information | | application |
| Locations of | AF/ | Locations of application represented by a list of |
| Application | NEF | data network access identifier(s) (DNAI(s)). |
| | | The NEF may map the AF-Service-Identifier |
| | | information to a list of DNAI(s) when the |
| | | DNAI(s) being used by the application are |
| | | statically defined. |
| Service | AF | Refers to the QoE per service flow as |
| Experience | | established in the SLA and during on boarding. |
| | | It can be either e.g., mean opinion score (MOS) |
| | | or video MOS as specified in International |
| | | Telecommunication Union (ITU)-T P.1203.3 or |
| | | a customized MOS |
| Timestamp | AF | A time stamp associated to the Service |
| | | Experience provided by the AF, mandatory if |
| | | the Service Experience is provided by the |
| | | application service provider (ASP). |

TABLE 2

| Information | Source | Description |
|---|---|---|
| Timestamp | 5G core | A time stamp associated with the collected |
| | (5GC) NF | information. |
| Location | AMF | The UE location information. |
| Subscription | AMF | If UE IDs are not provided as target of |
| permanent | | analytics reporting for slice service |
| identifier(s) | | experience, AMF returns the UE IDs |
| (SUPI(s)) | | matching the AMF event filters. |
| DNN | SMF | DNN for the PDU Session which contains |
| | | the QoS flow |
| Single-network | SMF | S-NSSAI for the PDU Session which |
| slice selection | | contains the QoS flow |
| assistance | | |
| information (S- | | |
| NSSAI) | | |
| Application | SMF | Used by NWDAF to identify the |
| ID | | application service provider and application |
| | | for the QoS flow |
| IP filter | SMF | Provided by the SMF, which is used by |
| information | | NWDAF to identify the service data flow |
| | | for policy control and/or differentiated |
| | | charging for the QoS flow |
| QFI | SMF | QoS Flow Identifier |
| QoS flow | UPF | The observed bit rate for uplink (UL) |
| Bit Rate | | direction; and The observed bit rate for |
| | | downlink (DL) direction |
| QoS flow | UPF | The observed Packet delay for UL |
| Packet Delay | | direction; and The observed Packet delay |
| | | for the DL direction |
| Packet | UPF | The observed number of packet |
| transmission | | transmission |
| Packet | UPF | The observed number of packet |
| retransmission | | retransmission |

TABLE 3

| Information | Source | Description |
|---|---|---|
| Timestamp | OAM | A time stamp associated with the collected |
| | | information. |
| Reference | OAM | The per UE measurement of the received power |
| Signal | | level in a network cell, including |
| Received | | synchronization signal (SS)-reference signal |
| Power | | received power (RSRP), channel state |
| | | information (CSI)-RSRP as specified in clause |
| | | 5.5 of TS 38.331 and evolved universal |
| | | terrestrial radio access (E-UTRA) RSRP as |
| | | specified in clause 5.5.5 of TS 36.331 |
| Reference | OAM | The per UE measurement of the received quality |
| Signal | | in a network cell, including SS-reference signal |
| Received | | received quality (RSRQ), CSI-RSRQ as |
| Quality | | specified in clause 5.5 of TS 38.331 and E- |
| | | UTRA RSRQ as specified in clause 5.5.5 of TS |
| | | 36.331 |
| Signal-to- | OAM | The per UE measurement of the received signal |
| noise and | | to noise and interference ratio in a network cell, |
| interference | | including SS-SINR, CSI-SINR, E-UTRA RS- |
| ratio | | SINR, as specified in clause 5.1 of TS 38.215 |

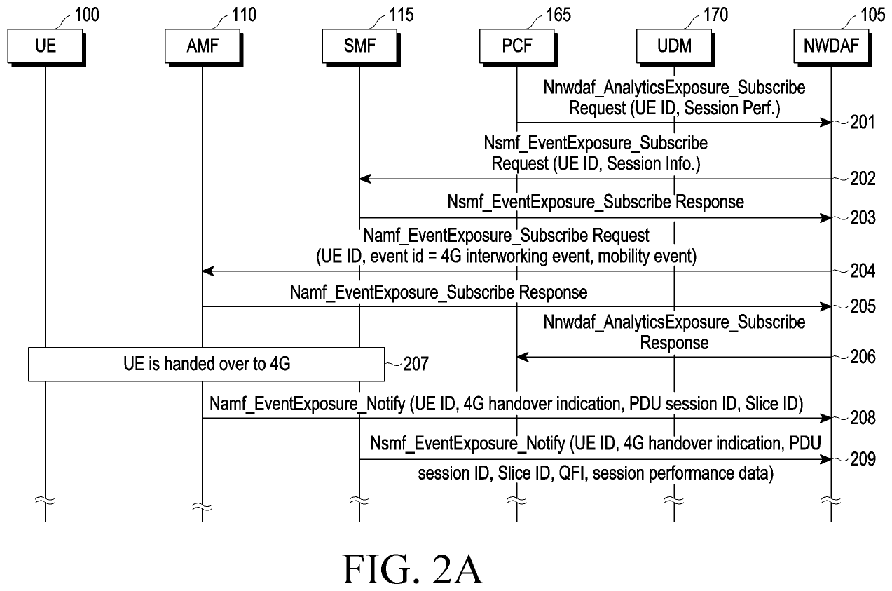

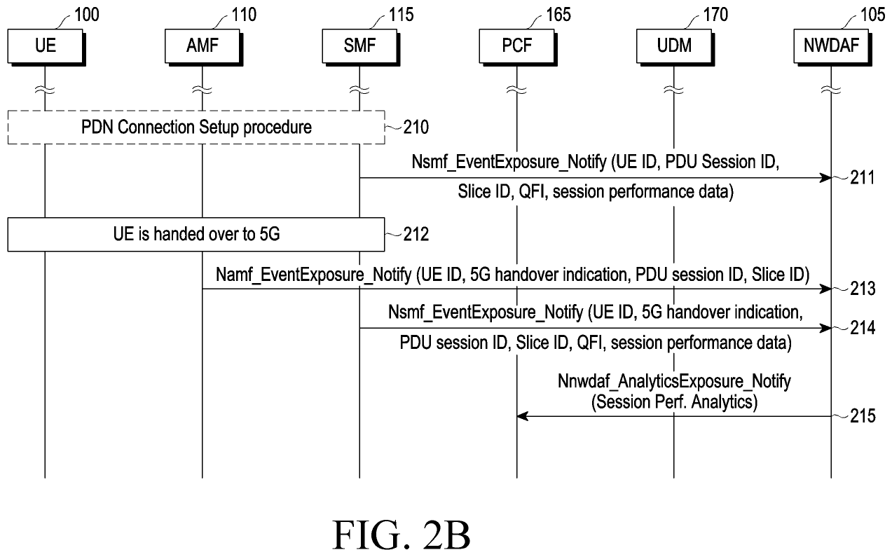

FIGS. 2A and 2B are signal flowcharts illustrating a network data collection and analytics operation according to various embodiments of the disclosure. In an embodiment of the disclosure, the NWDAF 105 may analyze the policy application status of the UE 100 by collecting network data according to operations to be described below. At least one of the steps described in the following embodiments may be omitted, modified, or changed in order.

Referring to FIGS. 2A and 2B, in operation 201, a PCF 165 may bypass a unified data management (UDM) 170 node and transmit a request message (e.g., Nnwdaf_AnalyticsExposure_Subscribe Request) for requesting network performance analytics to the NWDAF 105 to determine a UE route selection policy (URSP) to be provided to the UE 100. In an embodiment of the disclosure, the request message may include at least one of an identifier (e.g., a UE ID) of the UE 100 or a first parameter for designating network performance analytics. In an embodiment of the disclosure, the first parameter may include an analytics ID, and the analytics ID may be set to a value indicating session performance. For example, the first parameter may include ‘session performance’ for designating session performance data. In an embodiment of the disclosure, the first parameter may include at least one of a session ID, a slice ID (e.g., single-network slice selection assistance information (S-NSSAI)), a QoS flow ID (QFI), an application ID, a reporting period, or a data collection area related to the session to be analyzed, in order to designate data to be analyzed.

In operation 202, the NWDAF 105 receiving the request message for the network performance analytics from the PCF 165 may transmit a message (e.g., Nsmf_EventExposure_Subscribe Request) requesting data collection for at least one session of the UE 100 to the SMF 115 to collect the data for the network performance analytics. In an embodiment of the disclosure, the message may include at least one of an identifier (e.g., a UE ID) of the UE 100 or a second parameter (e.g., “session information”) designating all sessions or a specific session of the UE 100 requesting data collection. In an embodiment of the disclosure, the second parameter may include information for designating a session where data is to be collected, with reference to the content of the first parameter received from the PCF 165 in operation 201. In an embodiment of the disclosure, the second parameter may include at least one of a session ID, a slice ID (e.g., S-NSSAI), a QoS flow ID, an application ID, or a data collection area. In an embodiment of the disclosure, the second parameter may include period information for reporting the collected data determined based on the reporting period requested by the PCF 165.

In operation 203, the SMF 115 may transmit a response message (e.g., Nsmf_EventExposure_Subscribe Response) for accepting data collection to the NWDAF 105.

In operation 204, the NWDAF 105 receiving the request message for the network performance analytics from the PCF 165 may transmit a message (e.g., Namf_EventExposure_Subscribe Request) requesting data collection for at least one session of the UE 100 to the AMF 110 to collect the data for the network performance analytics. In an embodiment of the disclosure, the message may include at least one of an identifier (e.g., a UE ID) of the UE 100, event identifier (event id) or a parameter (e.g., “session information”) (not shown) designating all sessions or a specific session of the UE 100 requesting data collection. In an embodiment of the disclosure, the event identifier may be configured to indicate a 4^{th} generation (4G) interworking event and/or a mobility event.

In operation 205, the AMF 110 may transmit a response message (e.g., Namf_EventExposure_Subscribe Response) for accepting data collection to the NWDAF 105.

In operation 206, the NWDAF 105 may transmit, to the PCF 165, a response message (e.g., Nnwdaf_AnalyticsExposure_Subscribe Response) to the data analytics request of operation 201. In an embodiment of the disclosure, the NWDAF 105 may be configured to collect network data (e.g., performance data or network performance data) related to at least one session of the UE 100 from the AMF 110 and/or the SMF 115 and provide the PCF 165 with the analytics result based on the network data by the above-described operations (e.g., operations 201 to 205).

In operation 207, the UE 100 may move (e.g., hand over) to a second network (e.g., a 4G network) during communication. In an embodiment of the disclosure, the UE 100 may establish at least one session in the first network (e.g., the 5G network) including the AMF 110, the SMF 115, the PCF 165, and the NWDAF 105, and may move (e.g., hand over) to the second network while using the communication service through the at least one session.

In operation 208, if the UE 100 completes the movement to the 4G network, the AMF 110 may transmit a notification message (e.g., Namf_EventExposure_Notify) including information indicating that the UE 100 has moved to the 4G network to the NWDAF 105. In an embodiment of the disclosure, the message may include at least one of an identifier (e.g., the UE ID) of the UE 100, an indicator (e.g., the 4G handover indication) indicating that the UE 100 has moved to the 4G network, or information (e.g., the PDU session ID and/or the slice ID of the corresponding session) about at least one session (or all sessions of the UE 100) maintained or disconnected while the UE 100 moves to the 4G network.

In operation 209, if the UE 100 completes the movement to the 4G network, the SMF 115 may transmit, to the NWDAF 105, a notification message (e.g., Nsmf_EventExposure_Notify) including information collected for at least one session (e.g., a 5G PDU session) used by the UE 100 in the 5G network. In an embodiment of the disclosure, the message may include an identifier (e.g., the UE ID) of the UE 100, an indicator (e.g., the 4G handover indication) indicating that the UE 100 has moved to the 4G network, and performance information about at least one session of the UE 100. In an embodiment of the disclosure, the performance information for each session may include at least one of a session identifier (e.g., a PDU session ID), a slice ID (e.g., S-NSSAI), a QoS Flow ID (QFI), or session performance data (e.g., ‘session performance data’ collected in the 5G network before moving to the 4G network) related to each session (e.g., 5G PDU session).

From operations 208 and 209, the NWDAF 105 may be aware that the UE 100 has moved to the 4G network, and accordingly, the performance data received from the AMF 110 and/or the SMF 115 thereafter may be determined to correspond to the contents of communication of the UE 100 in the 4G network. In an embodiment of the disclosure, the session performance data may be parameters indicating the performance of each session, and may include, e.g., at least one of an uplink and downlink data transmission rate, a transmission delay, or a transmission error probability transmitted by the UE 100 through the corresponding session and slice or QoS flow.

In operation 210, the UE 100 may generate (e.g., set up) a new PDN connection in the 4G network. A PDU session identifier and a slice identifier corresponding to the new PDN connection may be designated by the UE 100 and a network entity (e.g., the SMF 115), respectively, in preparation for the movement to the 5G network during the PDN setup process.

In operation 211, the SMF 115 may bypass a UDM 170 node and report a notification message (e.g., Nsmf_EventExposure_Notify) including performance data for the PDN connection being used by the UE 100 in the 4G network to the NWDAF 105. In an embodiment of the disclosure, the message may include at least one of an identifier (e.g., the UE ID) of the UE 100, a PDU session identifier and/or a slice identifier corresponding to the PDN connection of the UE 100, a QoS Flow ID (QFI), or session performance data (e.g., ‘session performance data’ collected in the 4G network).

In operation 212, the UE 100 may move (e.g., hand over) to a first network (e.g., a 5G network).

In operation 213, if the UE 100 completes the movement to the 5G network, the AMF 110 may transmit a notification message (e.g., Namf_EventExposure_Notify) including information indicating that the UE 100 has moved to the 5G network to the NWDAF 105. In an embodiment of the disclosure, the message may include at least one of an identifier (e.g., the UE ID) of the UE 100, an indicator (e.g., the 5G handover indication) indicating that the UE 100 has moved to the 5G network, or information (e.g., the PDU session ID and/or the slice ID of the corresponding session) about at least one session (or all sessions of the UE 100) maintained or disconnected while the UE 100 moves to the 5G network.

In operation 214, if the UE 100 completes the movement to the 5G network, the SMF 115 may transmit, to the NWDAF 105, a notification message (e.g., Nsmf_EventExposure_Notify) including information collected for at least one session (e.g., a 4G session) used by the UE 100 in the 4G network. In an embodiment of the disclosure, the message may include at least one of an identifier (e.g., the UE ID) of the UE 100, an indicator (e.g., the 5G handover indication) indicating that the UE 100 has moved to the 5G network, or performance information about at least one session of the UE 100. In an embodiment of the disclosure, the performance information for each session may include at least one of a session identifier (e.g., a PDU session ID), a slice ID, a QoS Flow ID (QFI), or session performance data (e.g., ‘session performance data’ collected in the 4G network) related to each session (e.g., 4G session).

From operations 213 and 214, the NWDAF 105 may be aware that the UE 100 has moved to the 5G network, and accordingly, the performance data received from the AMF 110 and/or the SMF 115 thereafter may be determined to correspond to the contents of communication of the UE 100 in the 5G network.

In operation 215, the NWDAF 105 may analyze the data (e.g., session performance data) collected through the operations (e.g., at least one of operations 208, 209, 211, 213, and 214) and transmit, to the PCF 165, a message (e.g., Nnwdaf_AnalyticsExposure_Notify) including the performance analytics result (e.g., session performance analytics ‘Session perf. analytics’) according to at least one of the performance analytics by the UE 100 in the 5G network, performance analytics when moving to the 4G network, or performance analytics in the 4G network. In an embodiment of the disclosure, from the performance analytics result received from the NWDAF 105, the PCF 165 may determine a new UE path selection policy (URSP) to be applied to the UE 100 based on at least one of at least one session released when the UE 100 moves to the 4G network or session performance in the 4G network.

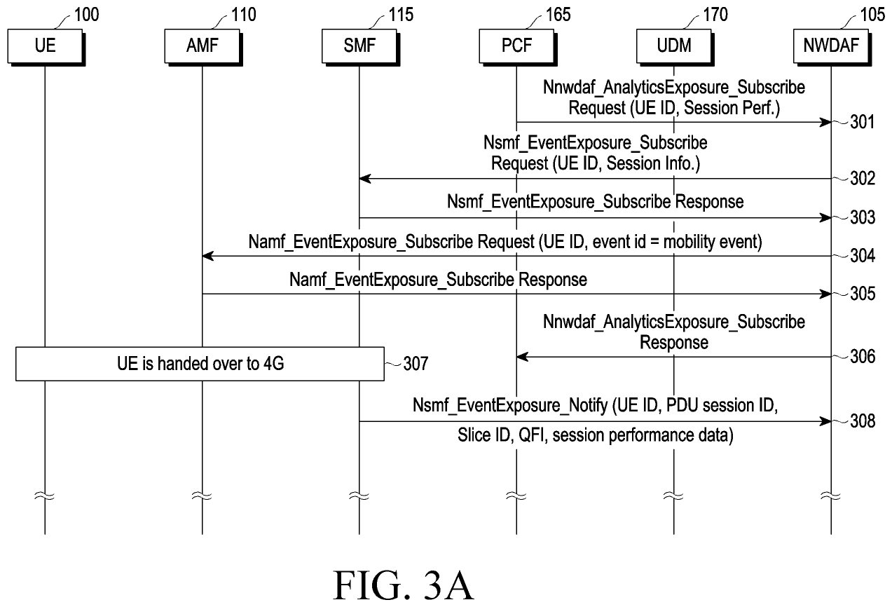

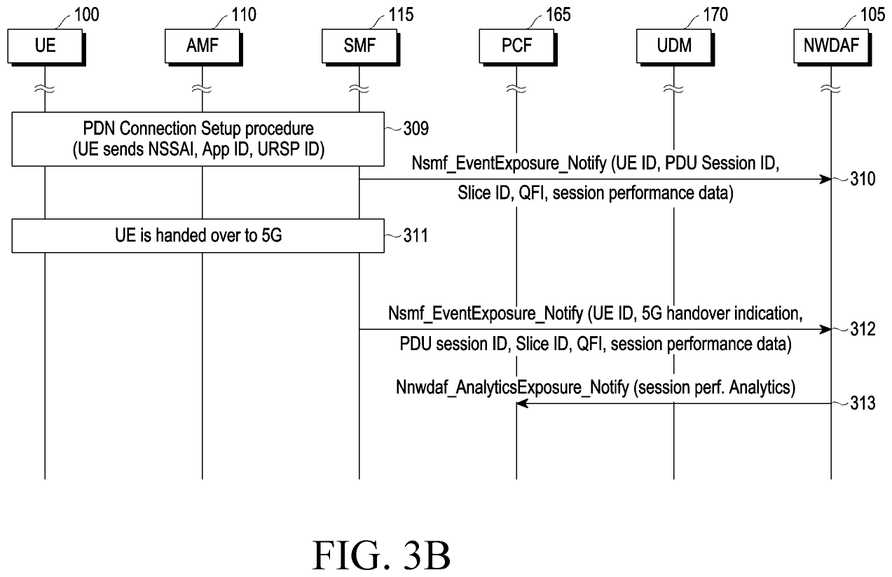

FIGS. 3A and 3B are signal flowcharts illustrating a network data collection and analytics operation according to various embodiments of the disclosure. In an embodiment of the disclosure, the NWDAF 105 may analyze the policy application status of the UE 100 by collecting network data according to operations to be described below. At least one of the steps described in the following embodiments may be omitted, modified, or changed in order.

Referring to FIGS. 3A and 3B, in operation 301, the PCF 165 may bypass a UDM 170 node and transmit a request message (e.g., Nnwdaf_AnalyticsExposure_Subscribe Request) for requesting network performance analytics to the NWDAF 105 to determine a UE route selection policy (URSP) to be provided to the UE 100. In an embodiment of the disclosure, the request message may include at least one of an identifier (e.g., a UE ID) of the UE 100 or a first parameter for designating network performance analytics. In an embodiment of the disclosure, the first parameter may include ‘session performance’ for designating session performance data. In an embodiment of the disclosure, the first parameter may be similar to the first parameter in operation 201.

In operation 302, the NWDAF 105 receiving the request message for the network performance analytics from the PCF 165 may transmit a message (e.g., Nsmf_EventExposure_Subscribe Request) requesting data collection for at least one session of the UE 100 to the SMF 115 to collect the data for the network performance analytics. In an embodiment of the disclosure, the message may include at least one of an identifier (e.g., a UE ID) of the UE 100 or a second parameter (e.g., “session information”) designating all sessions or a specific session of the UE 100 requesting data collection. In an embodiment of the disclosure, the second parameter may be similar to the second parameter in operation 202.

In operation 303, the SMF 115 may transmit a response message (e.g., Nsmf_EventExposure_Subscribe Response) for accepting data collection to the NWDAF 105.

In operation 304, the NWDAF 105 receiving the request message for the network performance analytics from the PCF 165 may transmit a message (e.g., Namf_EventExposure_Subscribe Request) requesting data collection for at least one session of the UE 100 to the AMF 110 to collect the data for the network performance analytics. In an embodiment of the disclosure, the message may include at least one of an identifier (e.g., a UE ID) of the UE 100, event identifier (event id) or a parameter (e.g., “session information”) (not shown) designating all sessions or a specific session of the UE 100 requesting data collection. In an embodiment of the disclosure, the event identifier may be set to indicate the mobility event.

In operation 305, the AMF 110 may transmit a response message (e.g., Namf_EventExposure_Subscribe Response) for accepting data collection to the NWDAF 105.

In operation 306, the NWDAF 105 may transmit, to the PCF 165, a response message (e.g., Nnwdaf_AnalyticsExposure_Subscribe Response) to the data analytics request of operation 301. In an embodiment of the disclosure, the NWDAF 105 may be configured to collect network data (e.g., performance data or network performance data) related to at least one session of the UE 100 from the AMF 110 and/or the SMF 115 and provide the PCF 165 with the analytics result based on the network data by the above-described operations (e.g., operations 301, 302, 303, 304, and 305).

In operation 307, the UE 100 may move (e.g., hand over) to a second network (e.g., a 4G network) during communication. In an embodiment of the disclosure, the UE 100 may establish at least one session in the first network (e.g., the 5G network) including the AMF 110, the SMF 115, the PCF 165, and the NWDAF 105, and may move (e.g., hand over) to the second network while using the communication service through the at least one session.

In operation 308, if the UE 100 completes the movement to the 4G network, the SMF 115 may transmit, to the NWDAF 105, a notification message (e.g., Namf_EventExposure_Notify) including information collected for at least one session (e.g., a 5G PDU session) used by the UE 100 in the 5G network. In an embodiment of the disclosure, the message may include at least one of an identifier (e.g., a UE ID) of the UE 100 or performance information about at least one session of the UE 100. In an embodiment of the disclosure, the performance information for each session may include at least one of a session identifier (e.g., PDU session ID), a slice ID, a QoS Flow ID (QFI), or session performance data (e.g., ‘session performance data’ collected in the 5G network) related to each session (e.g., 5G PDU session).

In operation 309, the UE 100 may generate (e.g., set up) a new PDN connection in the 4G network. A PDU session identifier and a slice identifier corresponding to the new PDN connection may be designated by the UE 100 and a network entity (e.g., the SMF 115), respectively, in preparation for the movement to the 5G network during the PDN setup process. In an embodiment of the disclosure, the UE 100 may transmit, to the SMF 115, at least one of a network identifier, an application identifier, or a URSP ID applied to session generation by applying the UE route setting policy (URSP) received by the UE 100 in the 5G network in a session generation procedure during a PDN setup process, by using, e.g., a protocol configuration option (PCO) field.

In operation 310, the SMF 115 may bypass a UDM 170 node and report a notification message (e.g., Nsmf_EventExposure_Notify) including performance data for the PDN connection being used by the UE 100 in the 4G network to the NWDAF 105. In an embodiment of the disclosure, the message may include at least one of an identifier (e.g., the UE ID) of the UE 100, a PDU session identifier and/or a slice identifier corresponding to the PDN connection of the UE 100, a QoS Flow ID (QFI), or session performance data (e.g., ‘session performance data’ collected in the 4G network).

In operation 311, the UE 100 may move (e.g., hand over) to a first network (e.g., a 5G network).

In operation 312, if the UE 100 completes the movement to the 5G network, the SMF 115 may transmit, to the NWDAF 105, a notification message (e.g., Nsmf_EventExposure_Notify) including information collected for at least one session used by the UE 100 in the 4G network. In an embodiment of the disclosure, the message may include at least one of an identifier (e.g., a UE ID) of the UE 100 or performance information about at least one session of the UE 100. In an embodiment of the disclosure, the performance information for each session may include at least one of a session identifier (e.g., a PDU session ID), a slice ID, a QoS Flow ID (QFI), or session performance data (e.g., ‘session performance data’ collected in the 5G network) related to each session (e.g., 5G PDU session).

In operation 313, the NWDAF 105 may analyze the data (e.g., session performance data) collected through the operations (e.g., at least one of operations 308, 310, and 312) and transmit, to the PCF 165, a message (e.g., Nnwdaf_AnalyticsExposure_Notify) including the performance analytics result (e.g., ‘Session performance analytics’) according to at least one of the performance analytics by the UE 100 in the 5G network, session maintenance performance analytics when moving to the 4G network or 5G network, or performance analytics in the 4G network. In an embodiment of the disclosure, from the performance analytics result received from the NWDAF 105, the PCF 165 may determine a new UE path selection policy (URSP) to be applied to the UE 100 based on at least one of at least one session released when the UE 100 moves to the 4G network or session performance in the 4G network.

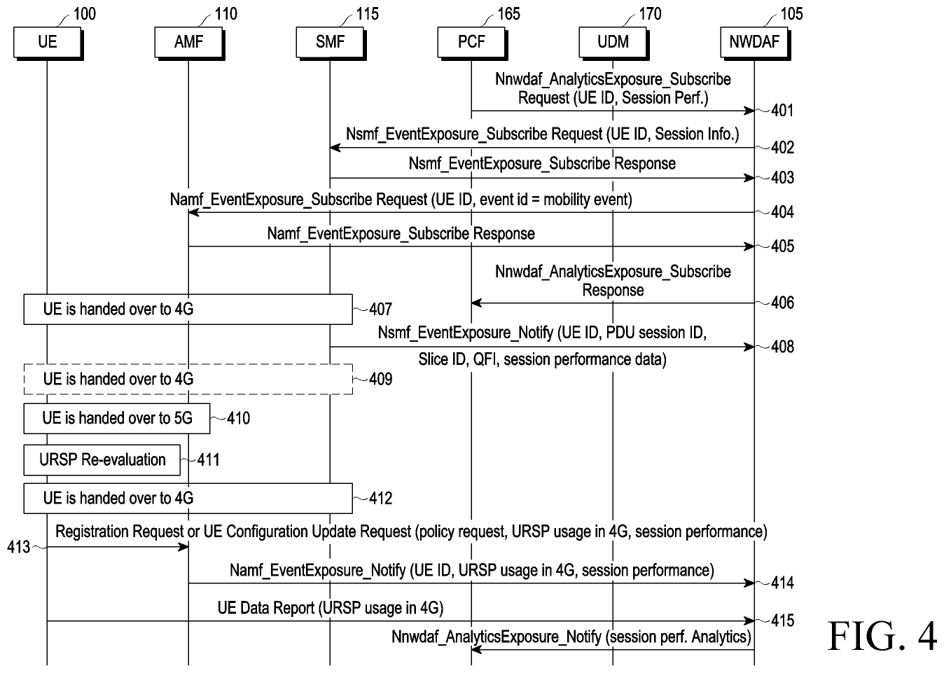

FIG. 4 is a signal flowchart illustrating a network data transfer operation according to an embodiment of the disclosure. In an embodiment of the disclosure, the NWDAF 105 may analyze the policy application status of the UE 100 by collecting network data according to operations to be described below. At least one of the steps described in the following embodiments may be omitted, modified, or changed in order.

Referring to FIG. 4, in operation 401, the PCF 165 may transmit a request message (e.g., Nnwdaf_AnalyticsExposure_Subscribe Request) for requesting network performance analytics to the NWDAF 105 to determine a UE route selection policy (URSP) to be provided to the UE 100. The request message may include at least one of an identifier (e.g., a UE ID) of the UE 100 or a first parameter for designating network performance analytics. In an embodiment of the disclosure, the first parameter may include ‘session performance’ for designating session performance data. In an embodiment of the disclosure, the first parameter may be similar to the first parameter in operation 201.

In operation 402, the NWDAF 105 receiving the request message for the network performance analytics from the PCF 165 may transmit a message (e.g., Nsmf_EventExposure_Subscribe Request) requesting data collection for at least one session of the UE 100 to the SMF 115 to collect the data for the network performance analytics. In an embodiment of the disclosure, the message may include at least one of an identifier (e.g., a UE ID) of the UE 100 or a second parameter (e.g., “session information”) designating all sessions or a specific session of the UE 100 requesting data collection. In an embodiment of the disclosure, the second parameter may be similar to the second parameter in operation 202.

In operation 403, the SMF 115 may transmit a response message (e.g., Nsmf_EventExposure_Subscribe Response) for accepting data collection to the NWDAF 105.

In operation 404, the NWDAF 105 receiving the request message for the network performance analytics from the PCF 165 may transmit a message (e.g., Namf_EventExposure_Subscribe Request) requesting data collection for at least one session of the UE 100 to the AMF 110 to collect the data for the network performance analytics. In an embodiment of the disclosure, the message may include at least one of an identifier (e.g., a UE ID) of the UE 100, an event identifier (an event id) or a parameter (e.g., “session information”) (not shown) designating all sessions or a specific session of the UE requesting data collection. In an embodiment of the disclosure, the event identifier may be set to indicate the mobility event.

In operation 405, the AMF 110 may transmit a response message (e.g., Namf_EventExposure_Subscribe Response) for accepting data collection to the NWDAF 105.

In operation 406, the NWDAF 105 may transmit, to the PCF 165, a response message (e.g., Nnwdaf_AnalyticsExposure_Subscribe Response) to the data analytics request of operation 401. In an embodiment of the disclosure, the NWDAF 105 may be configured to collect network data (e.g., performance data or network performance data) related to at least one session of the UE 100 from the AMF 110 and/or the SMF 115 and provide the PCF 165 with the analytics result based on the network data by the above-described operations (e.g., operations 401 to 405).

In operation 407, the UE 100 may move (e.g., hand over) to a second network (e.g., a 4G network) during communication. In an embodiment of the disclosure, the UE 100 may establish at least one session in the first network (e.g., the 5G network) including the AMF 110, the SMF 115, the PCF 165, and the NWDAF 105, and may move (e.g., hand over) to the second network while using the communication service through the at least one session.

In operation 408, if the UE 100 completes the movement to the 4G network, the SMF 115 may transmit, to the NWDAF 105, a notification message (e.g., Namf_EventExposure_Notify) including information collected for at least one session used by the UE 100 in the 5G network. In an embodiment of the disclosure, the message may include at least one of an identifier (e.g., a UE ID) of the UE 100 or performance information about at least one session of the UE 100. In an embodiment of the disclosure, the performance information for each session may include at least one of a session identifier (e.g., PDU session ID), a slice ID, a QoS Flow ID (QFI), or session performance data (e.g., ‘session performance data’ collected in the 5G network) related to each session (e.g., 5G PDU session).

In operation 409, the UE 100 may generate (e.g., set up) a new PDN connection in the 4G network. A PDU session identifier and a slice identifier corresponding to the new PDN connection may be designated by the UE 100 and a network entity (e.g., the SMF 115), respectively, in preparation for the movement to the 5G network during the PDN setup process. In an embodiment of the disclosure, the UE 100 may collect and store session performance data for at least one session being used in the 4G network.

In operation 410, the UE 100 may move (e.g., hand over) to a first network (e.g., a 5G network).

In operation 411, the UE 100 may re-evaluate the URSP in the 5G network.

In operation 412, the UE may generate (e.g., set up) a new session (e.g., PDU session) according to the URSP re-evaluated in operation 411.

In operation 413, the UE 100 may request the network (e.g., the AMF 110) to reconfigure the USSP through a registration request message or a UE configuration update request message. In an embodiment of the disclosure, the message (registration request message or UE configuration update request message) may include at least one of a parameter indicating a policy request by the UE 100, matching information (e.g., ‘URSP usage’) between the URSP ID and the session ID applied when generating each session in the 4G network, or session performance data (e.g., ‘session performance’ collected in the 4G network) in the 4G network of each session.

In operation 414, the AMF 110 may transmit a notification message (e.g., Namf_EventExposure_Notify) including the information collected for at least one session used by the UE 100 in the 4G network to the NWDAF 105. In an embodiment of the disclosure, the AMF 110 may be a data collection application function (DCAF) designated by the NWDAF 105, and may include the session performance data reported from the UE 100 in operation 413 in the message and transfer it to the NWDAF 105. In an embodiment of the disclosure, the message may include at least one of an identifier (e.g., a UE ID) of the UE 100 or performance information about at least one session of the UE 100. In an embodiment of the disclosure, the performance information for each session may include at least one of matching information (e.g., ‘URSP usage’) between the URSP ID and the session ID applied when each session is generated in the 4G network, or session performance data (e.g., ‘session performance’) in the 4G network of each session.

In operation 415, instead of operations 413 and 414, the UE may transmit a message (e.g., a UE Data Report) including performance information for each session to the NWDAF 105 through the data collection application function (DCAF) (not shown) designated by the NWDAF. In an embodiment of the disclosure, the performance information for each session may include at least one of matching information (e.g., ‘URSP usage’) between the URSP ID and the session ID applied when generating each session in the 4G network, or session performance data (e.g., ‘session performance’ collected in the 4G network) in the 4G network of each session.

In operation 416, the NWDAF 105 may analyze the data (e.g., session performance data) collected through the operations (e.g., operation 408 and operation 414 or 415) and transmit, to the PCF 165, a message (e.g., Nnwdaf_AnalyticsExposure_Notify) including the performance analytics result according to at least one of the performance analytics by the UE 100 in the 5G network, session maintenance performance analytics when moving to the 4G network or 5G network, or performance analytics in the 4G network. In an embodiment of the disclosure, from the performance analytics result received from the NWDAF 105, the PCF 165 may determine a new UE path selection policy to be applied to the UE 100 based on at least one of at least one session released when the UE 100 moves to the 4G network or session performance in the 4G network.

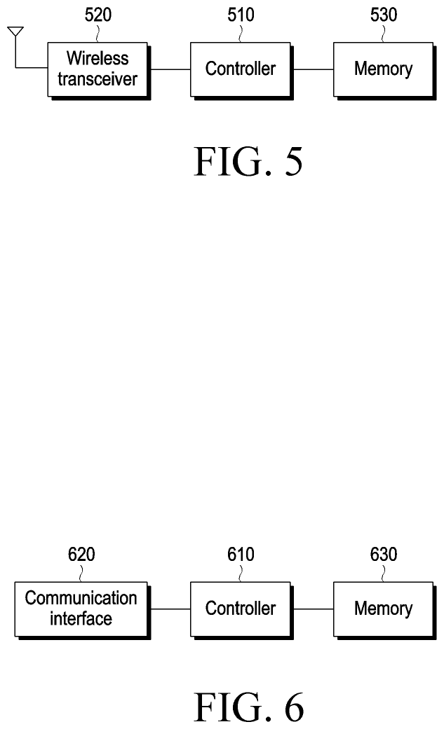

FIG. 5 is a block diagram illustrating a configuration of a UE according to an embodiment of the disclosure.

Referring to FIG. 5, the UE 100 may include a wireless transceiver 520, a controller 510, and a memory 530. According to the above-described communication method for the UE 100, the controller 510, the wireless transceiver 520, and the memory 530 of the UE 100 may operate. However, the components of the UE 100 are not limited to the above-described examples. For example, the UE may include more or fewer components than the above-described components. Further, at least one of the controller 510, the wireless transceiver 520, and the memory 530 may be implemented in the form of a single chip.

The wireless transceiver 520 collectively refers to the transmitter of the UE 100 and the receiver of the UE 100 and may transmit and receive signals to/from the base station (e.g., the RAN 120) or network entity. The signals transmitted/received with the base station may include control information and data. In an embodiment of the disclosure, the wireless transceiver 520 may include a radio frequency (RF) transmitter for frequency-up converting and amplifying signals transmitted and an RF receiver for low-noise amplifying signals received and frequency-down converting the frequency of the received signals. The wireless transceiver 520 may include a wired/wireless transceiver and may include various components for transmitting/receiving signals.

The wireless transceiver 520 may receive signals via a radio channel, output the signals to the controller 510, and transmit signals output from the controller 510 via a radio channel. The wireless transceiver 520 may receive and output communication signals to the controller 510 and transmit the signals output from the controller 510 to a network entity (e.g., the RAN 120, the AMF 110, or the SMF 115) through a wired/wireless network.

The memory 530 may store a program and data necessary to operate the UE 100. The memory 530 may store control information or data that is included in the signal obtained by the UE. The memory 530 may include a storage medium, such as a read only memory (ROM), a random access memory (RAM), a hard disk, a compact disc (CD)-ROM, or a digital versatile disc (DVD), or a combination of storage media.

The controller 510 may control a series of operations to allow the UE 100 to operate according to at least one or a combination of the above-described embodiments. The controller 510 may include at least one processing circuit. For example, the controller 510 may include a communication processor (CP) that performs control for communication and an application processor (AP) that controls an upper layer, such as an application program.

FIG. 6 is a block diagram illustrating a configuration of a network entity according to an embodiment of the disclosure.

Referring to FIG. 6, a network entity of the disclosure (e.g., at least one of the RAN 120, the AMF 110, the SMF 115 or the NWDAF 105) may include a communication interface 620, a memory 630, and a controller 610. The controller 610, communication interface 620, and memory 630 of the network entity may operate according to the above-described communication methods by the network entity. However, the components of the network entity are not limited thereto. For example, the network entity may include more or fewer components than the above-described components. Further, at least one of the controller 610, the communication interface 620, and the memory 630 may be implemented in the form of a single chip.

The communication interface 620 collectively refers to the receiver of the network entity and the transmitter of the network entity and may transmit and receive signals to/from the UE 100 or another network entity. In this case, the signals transmitted/received with the base station may include control information and data. The communication interface 620 may include a wired and/or wireless transceiver and may include various components for transmitting/receiving signals.

The communication interface 620 may receive a signal through a communication channel (e.g., a wireless channel or a wired channel), output the signal to the controller 610, and transmit the signal output from the controller 610 through the communication channel. The communication interface 620 may receive the communication signal and output it to the controller 610 and transmit the signal output from the controller 610 to the UE or another network entity through the wired/wireless network.

The memory 630 may store programs and data necessary for the operation of the network entity. The memory 630 may store control information or data that is included in the signal obtained by the network entity. The memory 630 may include a storage medium, such as a ROM, a RAM, a hard disk, a CD-ROM, or a DVD, or a combination of storage media.

The controller 610 may control a series of processes to allow the network entity to operate according to at least one or a combination of the above-described embodiments. The controller 610 may include at least one processing circuit. The methods according to the embodiments described in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in a memory constituted of a combination of all or some thereof. As each constituting memory, multiple ones may be included.

The programs may be stored in attachable storage devices that may be accessed via a communication network, such as the Internet, Intranet, local area network (LAN), wide area network (WAN), or storage area network (SAN) or a communication network configured of a combination thereof. The storage device may connect to the device that performs embodiments via an external port. A separate storage device over the communication network may be connected to the device that performs embodiments.

A method for collecting and analyzing session performance data in a wireless communication system according to an embodiment may comprise receiving (operations 201 and 301) a first request message for requesting network performance analytics from a policy control function (PCF), transmitting (operations 202, 204, 302, and 304) a second request message for requesting data collection for the network performance analytics to at least one network function (NF) of a first network related to session performance of a user equipment (UE), receiving (operations 208, 209, and 308) a first notification message including session performance data of the first network and an indicator indicating that the UE moves to a second network from the at least one network function, and transmitting (operations 215 and 313), to the PCF, a second notification message including a performance analytics result of the session performance data.

In an embodiment of the disclosure, the at least one NF may include at least one of an access and mobility management function (AMF) or a session management function (SMF).

In an embodiment of the disclosure, the first request message may include a first parameter designating a request for session performance data for the network performance analytics.

In an embodiment of the disclosure, the second request message may include a second parameter designating at least one session of the UE requesting data collection for the network performance analytics.

In an embodiment of the disclosure, the first notification message may include a protocol data unit (PDU) session identifier (ID) and/or a slice ID related to each session of the UE, and the second notification message may include at least one of the PDU session ID, the slice ID, or a quality-of-service (QoS) flow ID (QFI).

In an embodiment of the disclosure, the method may further comprise receiving (operations 211 and 310) a third notification message including performance data for a packet data network (PDN) connection being used by the UE in the second network from the at least one network function.

An apparatus in a network data collection and analytics function (NWDAF) of a wireless communication system according to an embodiment may comprise a communication interface, a memory, and a controller. The controller may be configured to receive (operations 201 and 301) a first request message for requesting network performance analytics from a policy control function (PCF), transmit (operations 202, 204, 302, and 304) a second request message for requesting data collection for the network performance analytics to at least one network function (NF) of a first network related to session performance of a user equipment (UE), receive (operations 208, 209, and 308) a first notification message including session performance data of the first network and an indicator indicating that the UE moves to a second network from the at least one network function, and transmit (operations 215 and 313), to the PCF, a second notification message including a performance analytics result of the session performance data.

The embodiments herein are provided merely for better understanding of the disclosure, and the disclosure should not be limited thereto or thereby. In other words, it is apparent to one of ordinary skill in the art that various changes may be made thereto without departing from the scope of the disclosure. Further, the embodiments may be practiced in combination. For example, the respective, at least portions, of the embodiments of the disclosure may be combined and operated by the base station or the UE.

In the above-described specific embodiments of the disclosure, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for collecting and analyzing session performance data by a network data collection and analytics function (NWDAF) in a wireless communication system, the method comprising:
receiving a first request message for requesting network performance analytics from a policy control function (PCF);
transmitting a second request message for requesting data collection for the network performance analytics to at least one network function (NF) of a first network related to session performance of a user equipment (UE);
receiving a first notification message including session performance data of the first network and an indicator indicating that the UE moves to a second network from the at least one network function; and
transmitting, to the PCF, a second notification message including a performance analytics result of the session performance data.

2. The method of claim 1, wherein the at least one NF includes at least one of an access and mobility management function (AMF) or a session management function (SMF).

3. The method of claim 1, wherein the first request message includes a first parameter designating a request for session performance data for the network performance analytics.

4. The method of claim 1, wherein the second request message includes a second parameter designating at least one session of the UE requesting data collection for the network performance analytics.

5. The method of claim 1, wherein the first notification message includes a protocol data unit (PDU) session identifier (ID) and/or a slice ID related to each session of the UE.

6. The method of claim 5, wherein the second notification message includes at least one of the PDU session ID, the slice ID, or a quality-of-service (QoS) flow ID (QFI).

7. The method of claim 1, further comprising:
receiving a third notification message including performance data for a packet data network (PDN) connection being used by the UE in the second network from the at least one network function.

8. A network data collection and analytics function (NWDAF) of a wireless communication system, the NWDAF comprising:
a communication interface;
a memory; and
at least one processor,
wherein the at least one processor is configured to:
receive a first request message for requesting network performance analytics from a policy control function (PCF),
transmit a second request message for requesting data collection for the network performance analytics to at least one network function (NF) of a first network related to session performance of a user equipment (UE),
receive a first notification message including session performance data of the first network and an indicator indicating that the UE moves to a second network from the at least one network function, and
transmit, to the PCF, a second notification message including a performance analytics result of the session performance data.

9. The NWDAF of claim 8, wherein the at least one NF includes at least one of an access and mobility management function (AMF) or a session management function (SMF).

10. The NWDAF of claim 8, wherein the first request message includes a first parameter designating a request for session performance data for the network performance analytics.

11. The NWDAF of claim 8, wherein the second request message includes a second parameter designating at least one session of the UE requesting data collection for the network performance analytics.

12. The NWDAF of claim 8, wherein the first notification message includes a protocol data unit (PDU) session identifier (ID) and/or a slice ID related to each session of the UE.

13. The NWDAF of claim 12, wherein the second notification message includes at least one of the PDU session ID, the slice ID, or a quality-of-service (QoS) flow ID (QFI).

14. The NWDAF of claim 8, wherein the at least one processor is further configured to receive a third notification message including performance data for a packet data network (PDN) connection being used by the UE in the second network from the at least one network function.
